(19) United States
(12) Patent Application Publication
(10) Pub. No.: US 2003/0194030 A1
(43) Pub. Date: Oct. 16, 2003

(54) Power line interference compensation in PCM upstream transmissions

(76) Inventor: Cory Samuel Modlin, Chevy Chase, MD (US)

Correspondence Address: Warren Franz, Texas Instruments Incorporated, P.O. Box 655474, MS 3999, Dallas, TX, 75265, US

(21) Appl. No.: 10/122,073

(22) Filed: Apr. 15, 2002

(51) Int. Cl. H04B 1/10

(52) U.S. Cl. 375/346; 375/242

(57) ABSTRACT

The present invention relates to a method for filtering and compensating power line interference and DC distortion in PMC upstream data transmissions. To reduce effects of power line interference and DC distortion, the preferred embodiment of the present invention implements extremely narrow IIR notch filters, nominally at 0 Hz, 60 Hz, and 180 Hz (and optionally at 300 Hz) if interference at these frequencies is detected. These filters cause very little distortion. Then, because power line frequencies may drift from their nominal frequencies of the filters are adapted to track the exact frequencies. To effectiveliy eliminate the distortion caused by the IIR filter, the data mode transmit equalizes is adjusted.

### CROSS-REFERENCE TO RELATED APPLICATIONS

None

### FIELD OF THE INVENTION

The present invention relates generally to the removal of line noise in a PCM upstream data communications system. More particularly, the present invention relates to a method for filtering and compensating power line interference in PCM upstream data transmissions.

### BACKGROUND OF THE INVENTION

Personal computers connecting to networks through the public switched telephone system (PST) typically use a modem to dial-up a network connection through analog telephone lines. These client, or end user, modems transmit data signals converted to digital source through an analog channel through a network. Due to the increase in data, voice, and facsimile traffic over the telecommunications infrastructures methods to increase the digital and analog transfer rates through modems over telephone lines are extremely useful and necessary to adhere to International Telecommunication Union (ITU) standards.

The Telecommunication Standardization Sector of the ITU (ITU-T) adopted V.34 Recommendation in 1994, which is incorporated herein, to define modern operating speeds from 28.8 kilobyte per second (kbps) up to 33.6 kbps. However, data transfer rates are limited over the PSTN. In modems built to V.34 standards of the International Telecommununications Union (ITU), and all previous voice-band modem standards, carrier-modulated quadrature amplitude modulation (QAM) is used to quantize the analog signals using u-law (or A-law for some standards outside of the U.S.) pulse code modulation (PCM) codecs. In such a system, the carrier frequency and symbol rate are chosen to match the channel, not the codec. However, in many cases there is a direct digital connection upstream of the analog client modem between a central office (CO) of the PSTN and a server modem on a digital network. PCM modems are built to take advantage of networks used by internet service providers or others connected to the PSTN through a digital connection, such as T1 in the United States and E1 in Europe. PCM modems use either standards for “PCM downstream” modulation, as described in ITU V.90, or “PCM upstream, as described in ITU V.92 recommendations. A connection between a client modem on a local loop of the PSTN and a connection on the digital network can be referred to as a “PCM channel”.

In PCM downstream, data is transmitted in PCM mode downstream from a central office to an end user's analog modem, i.e. from server to client The upstream digital PCM modem transmits over a digital network in eight bit digital words called octets that correspond to different central office codec output levels. At the client modem's central office, the octets are converted to analog levels which are transmitted over an analog loop. The client PCM modem then converts the analog levels back to digital signals, or pulse code amplitude CAM) signals, and into equalized digital levels. The equalized digital levels are ideally mapped back into the originally transmitted octets that the octets represent

When using PCM downstream modulation, the client modem synchronizes to the central office codec and tries to determine exactly which PCM sample was transmitted in each sample. In codecs throughout the world, the codec clock is 8000 Hz. Since there are 255 different u-law levels and 256 different A-law levels, the data rates could go as high as nearly 64 kbps (8 bits/sample at 8000 samples/second). Practically, because the smallest levels are often too small to distinguish and because of regulatory power limits on the transmit signal, the highest data rate is listed as 56 kbps although even that is usually higher than what most channels will support. In PCM downstream, the client modem must implement an equalizer to undo the effects of intersymbol interference caused by the channel (the telephone line plus the analog front-end of the codec and client modems) in order to recover the PCM levels.

In PCM upstream modulation, the client modem transmits analog levels corresponding to data to be transmitted to the digital server modem over an analog telecommunications line. The analog levels are modified by the channel characteristics of the analog line. The modified levels are quantized to form octets by a codec in the central office. In PCM upstream, the channel comes before the codec, further limiting the highest possible data rate. The codec then transmits the octets to the PCM server modem over the digital network. At the server modem, the transmitted levels are demodulated from the octets, thereby recovering the data sent from the client modem.

If the client modem were simply to transmit PCM levels, the channel would distort the levels so that when it reached the codec, they would not resemble the transmitted levels at all. The server modem is not able to equalize the receive signals until after the codec and therefore can not limit the effect of quantization noise. In order to take advantage of the PCM codec in the upstream direction, the client modem must implement an equalizer in the transmitter to undo the effects of intersymbol interference.

There are a number of factors that limit the PCM upstream data rate more than the PCM downstream data rate and provide additional challenges. Regulatory limits on the client modem transmit power mean that the higher the upstream channel attenuation, the lower the upstream data rate. In the downstream direction, only the signal-to-noise ratio (SNR) limits downstream performance. The echo from the downstream signal is added before the codec. Even a perfect echo canceller in the server modem can not remove the quantization noise caused by the echo. The equalizer in the client transmitter can not continually adapt to changing channel conditions as can the receive equalizer used for PCM downstream. The only way to adapt the transmit equalizer is for the server to notify the client through a rate renegotiation. The timing recovery in the upstream direction is more difficult that in the downstream direction. Due to these and other problems in PCM upstream transmissions, the levels transmitted by the client PCM modem are modified. Since these modified levels are quantized to form octets by the codec, and not the levels that are actually transmitted, it can be difficult for the server modem to accurately determine from the octets the data being transmitted by the client modem.

### BRIEF DESCRIPTION OF THE DRAWINGS

Preferred embodiments of the invention are discussed hereinafter in reference to the drawings, in which:

FIG. 1 is a diagram of a PCM a communications network;

FIG. 2 is a diagram of a PCM upstream channel;

FIG. 3 is a PCM channel with robbed bit signaling;

FIG. 4 is a diagram of a direct form infinite impulse response filter.

FIG. 5 is a graph of suppressor filter frequency response.

FIG. 6 is a graph of suppressor filter frequency response.

### DETAILED DESCRIPTION OF THE INVENTION

There is described herein a technique for equalizer designs and channel error detections for a PCM upstream data transmission between a digital PCM server modem and a PCM analog client modem.

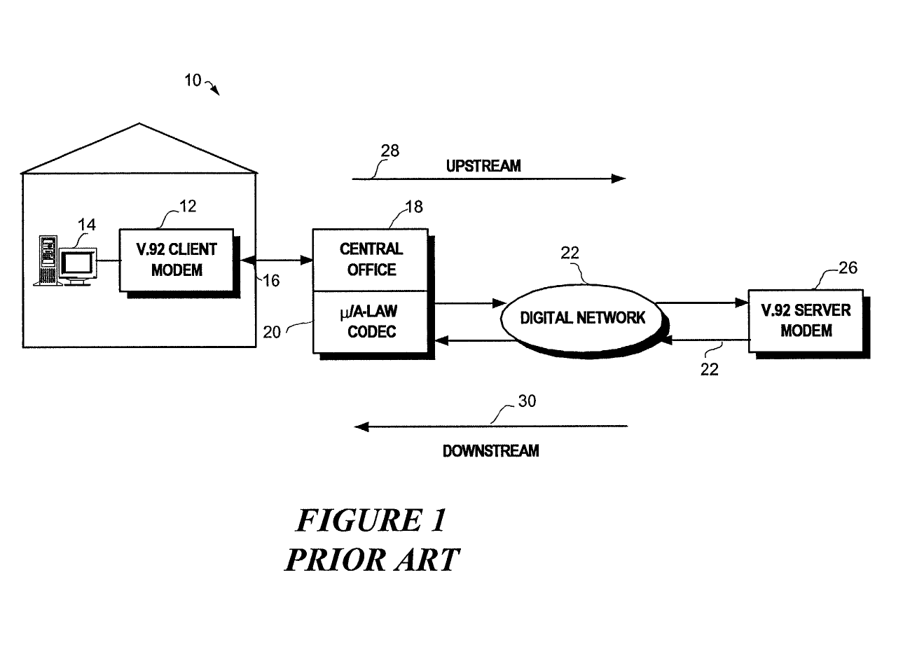

When connecting two modems over the public switched telephone network (PSTN), digital data from a central office (CO) often must be translated from digital signals at the server modem into analog tones for transmission over a local analog line to a client modem. At each client modem, the received analog waveform is sampled and quantized by an analog to digital convertor (A/D). A PCM upstream network with a voice-band modem 12 connection is illustrated in FIG. 1. The network 10 includes a V.92 PCM client modem from an end user's personal computer 14 connected to an analog telephone line 16, or channel. The analog channel 16 is connected to a telephone company central office (CO) 18 wherein the analog levels are quantized using a μ- or A-law codec 20. There is also a digital network 22 which is interconnected to the CO 18 and to the digital transmission channel, which may comprise a T1, E1, or ISDN line 24. A V.92 server modem 26 completes the connection in the upstream direction. Data may transmit in either the downstream direction (server to client modem) 28 or the upstream direction 30 (client to server modem).

For digital symbols transmitted over the analog channel to be reasonably free of intersymbol interference over the frequency spectrum used by the symbols, modems employ adaptive filters called equalizers. Equalization is a technique used to compensate for distortion in analog signal lines. One of the distortions which is compensated for is intersymbol interference. Equalizers in a receiver neutralize intersymbol interference which would cause high bit error rates if left uncompensated. Equalization is accomplished by passing the digital signal through a filter whose tap coefficients are adjusted so that the combination of channel plus equalizer is some known response. When the channel is properly equalized, data can be recovered reliably from the received symbols. Modems equalize the incoming signals by employing various types of equalizers include linear equalizers, decision-feedback equalizer, and trellis-based Viterbi equalizers. The equalizer taps of a minimum mean-square-error decision-feedback equalizer (MMSE-DFE) can be directly computed by Givens rotations without back-substitution and matrix-vector multiplication, as discussed in the paper “An Improved Fast Algorithm for Computing the MMSE Decision-Feedback Equalizer” by Bin Yang, Int. J. Electron. Commun., 51 (1999) No. 1, 1-8, which is incorporated herein by reference.

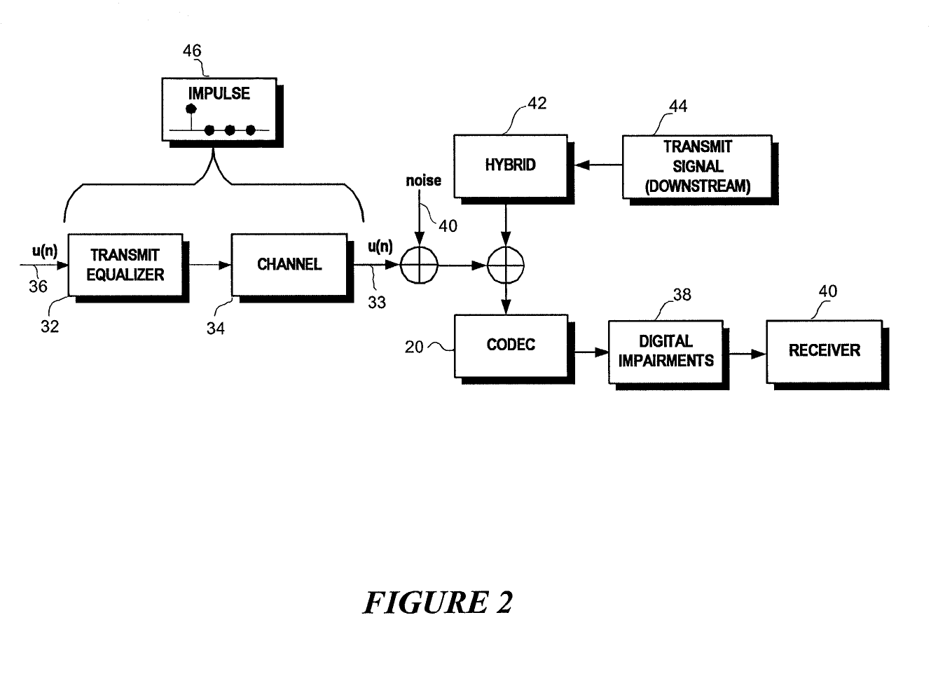

Referring to FIG. 2, there is illustrated in block diagram the effective PCM upstream channel 34. In this figure, the transmit equalizer 32 is designed to undo the negative effects of the channel so that the same signal, u(n) 36, appears before and after the combination of the equalizer 32 and channel 34. The input values, u(n), are chosen from a constellation of points as determined by the server modem 26 (see section 6.4.2 in ITU-T/V.92). Because of the echo, the constellation of points will not correspond exactly to the PCM codec levels. However, it is still true, as in PCM downstream modulation, that there are more constellation points possible at smaller signal levels than at larger levels.

Digital impairments 38 include digital pads (digital gain) and robbed-bit-signaling (RBS). RBS is a technique used in T1 network connections where the least significant bit of each nth data octet is replaced with a control bit by the network for control signaling. For any one RBS link, the frequency of robbed bits through a single T1 connection is one every sixth symbol. This “in-band” signaling is used to indicate things like “off-hook”, “ringing”, “busy signal”, etc. RBS results in data impairment by changing transmitted bit values. RBS must be detected and the signaling bit ignored when present Another problem with RBS in networks is where the link between two modems includes several different digital legs such that the number of RBS links is variable from one connection to another.

As mentioned previously, locking the upstream transmitter clock to the CO clock is more challenging than doing timing recovery in the downstream direction. A reasonable client modem implementation might use a phase-locked loop (PLL) for rough timing recovery and might use receive equalizer adaptation for finer timing recovery. Typically, the receiver equalizer updates react more quickly than does a PLL. An equalizer is used in the PCM upstream receiver of the present invention. However, the equalizer comes after the codec and can not prevent upstream timing drift from adding quantization noise. Finally, power line noise interference 40 comes before the codec 20 in PCM upstream. Cancellation after the codec 20 will not eliminate the added quantization noise and will distort the received signal.

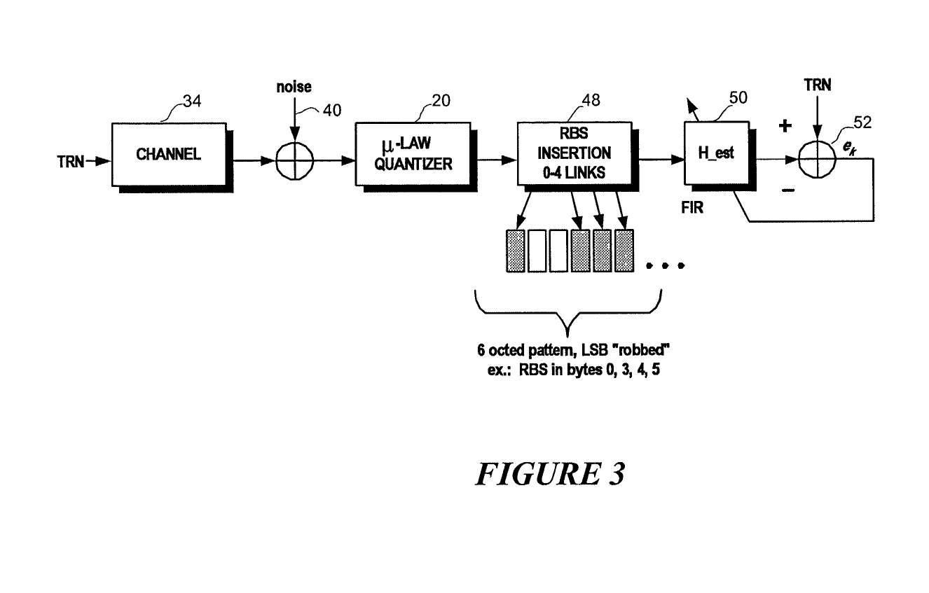

To design the data mode upstream equalizer for PCM upstream, a channel identification is performed both during V.92 training events TRN1u and TRN2u. This provides adequate time for the channel to converge. An unbiased channel identification can be performed using least mean squares (LMS). The length of the channel is 96 samples, and the filters will converge in less than 2 seconds with LMS. FIG. 3 is a block diagram illustrating the LMS update setup. Once the estimate of the channel, H_est 50, has converged, the power of the error signal, eₖ 52, should be close to the average power of the additive noise and quantization noise.

Robbed bit signaling (RBS) 48 is present is nearly all T1 connections but is not present in E1. In RBS, the least significant bit in every 6^{th} μ-law sample is replaced (or robbed) with signaling information. The signaling pattern is never longer than 4 bits long. Therefore, the pattern repeats every 24 μ-law samples. There can also be more than one RBS signaling channel. One channel might affect samples 0, 6, 12, 18, . . . while a second channel might affect samples 3, 9, 15, 21, . . . . The PN3857 test standard allows for up to four RBS links. RBS will also affect the constellation design in PCM upstream. When there is RBS, the space between adjacent μ-law samples effectively doubles. Therefore, the phase(s) containing RBS should be detected an tracked.

RBS detection in the upstream direction can be simplified since the μ-law samples are directly accessed. Over some period where any signal is being received, the least significant bit (LSB) from a block of 24 samples is stored. Then, these bits are compared to the subsequent block of 24 samples. The phases on which there is no RBS are expected to vary randomly between 1 and 0. On those samples with RBS, the same values are detected in every block, while the number of differences detected are tracked. If there is no RBS, the probability of k differences in n observations of the LSB is

$$P = ( \begin{matrix}n \\ k\end{matrix} ) \cdot {5}^{n}$$

For 100 observations, the probability of fewer than eight (for example) observed bit differences is ˜10⁻¹⁹. RBS is detected if fewer than eight differences are observed on any of the 24 phases.

Once RBS is detected, samples with RBS can be adjusted to compensate for the average offset This will affect the identified channel and the designed equalizer. The received samples can be adjusted by converting to a linear sample halfway between the RBS sample and the RBS sample with the RBS bit inverted. For example, if a sample known to have RBS inserted is received with value μ=50, then the RBS bit was 0. The linear value corresponding to μ=50 is −3644 and to μ=51 is −3516. The linear sample should be set to the average of −3580.

The power line interference is added before the codec and before the channel in PCM upstream implementation. Since most codecs have transformers that reject DC, the 60 Hz component will be greatly attenuated. Based on tests with the TAS, there is almost 28 dB of attenuation at 60 Hz. There is little attenuation, however, above 150 Hz. The TR30 document, PN 3857 “North American Telephone Network Transmission Model for Evaluating Analog Client and Digitally Connected Server Modems,” which is incorporated herein, is used to test and evaluate voice-band modems. This documents discloses the presence of interference from power lines in North America where the power line fundamental frequency is 60 Hz and describes interference at 60 Hz and at odd harmonics 180 Hz, 300 Hz and 540 Hz.

Observing the 180 Hz interference levels in Table I, power levels in dBm can be converted to dBm by subtracting 90 dB. Therefore, the maximum power of the 180 Hz interference is −50 dBm.

TABLE I
Power Range From PN 3857 Draft 14.

| Interference Frequency | power (dBrn) |
|---|---|
| 60 Hz | 35-52 |
| 180 Hz | 23-40 |
| 300 Hz | 0-29 |
| 540 Hz | 0-20 |

Power line interference can degrade performance in any data connection. The power line interference should be at least 10-15 dB below the noise caused by echo and any other unavoidable noise sources to limit its effect on error rates. For example, if power line interference is 10 dB below other noise sources, it will cause a 10*log 10(1.1)=0.41 dB SNR penalty. The primary source of noise in PCM upstream connections comes from quantizing the echo. The highest trans-hybrid loss described in PN3857 is 18 dB. If the server transmits at −12 dBm, the power of the echo will be −30 dBm.

To determine the amount of quantization noise that is caused by an echo at −30 dBm, the codec is evaluated. For small receive signals (worst case), the echo is likely to reach into the fifth μ-law codec chord. Assuming the noise is uniformly distributed between any two PCM levels within this chord, the quantization noise level is 10*log 10(128²/12)−84.3=−53 dBm. Therefore, the interference at 180 Hz needs to be brought from −50 dBm to about 10-15 dB below the −53 dBm noise level caused by the echo. This implies that between 13 and 18 dB of suppression is necessary to avoid a performance loss. If the hybrid loss is smaller, less suppression is needed.

This quantization noise calculation is conservative because the channel attenuates the interference signals before they reach the codec and there are other sources of noise, most notably, timing jitter in the client transmitter. Even taking this into account, some suppression is definitely required at 180 Hz, and possibly at 60 Hz and 300 Hz. The levels at 540 Hz are well below the noise floor and do not require filtering.

In V.34, the power line interference can be addressed with an equalizer and high pass filter in the receiver. With PCM upstream, power line interference can not be addressed in the same way as in V.34 for two reasons. First, the power line interference comes before the codec and any equalizers that we could design come after the codec. Although this is also true in V.34, the V.34 modulation treats the quantizer as noise whereas in PCM upstream, the receive signal must match certain levels as prescribed by the quantizer. If a data mode transmit equalizer for PCM upstream and constellation was designed without regard to the receive equalizer, the levels received at the codec would be correct if the power line noise was ignored. However, the receive equalizer would distort the signal, therefore making it impossible to decipher the data. If instead the transmit data mode equalizer is designed so that the levels are correct after the equalizer, then the received signal at the codec would be distorted, adding significant quantization noise. The second difference with V.34 is that the PCM upstream signal occupies a wider band and will typically extend below 180 Hz.

One solution to address power line interference is to add a finite impulse response (FIR) equalizer. However, an FIR equalizer that would notch out only the power line interference without affecting other frequencies would be prohibitively long. Even ignoring the DSP memory resource issues, or MIPS (millions of instruction cycles per second), required by a very long equalizer, the misadjustment or added noise from the LMS updates would severely limit performance. Any adaptive equalizer using LMS will attempt to minimize the average error which includes the quantization noise. In V.34 this is the optimal approach since the quantization noise is not handled any differently than other noise sources. In PCM upstream, however, quantization is treated differently than other sources of noise since the upstream transmitter is synchronized to the codec and the upstream signal is designed to hit pre-determined levels driven by the quantizer. An adaptive equalizer that brings the overall noise level up to the quantization noise level will cause the performance of PCM upstream to fall below that of V.34.

To reduce effects of power line interference, the preferred embodiment of the present invention implements extremely narrow IIR notch filters, nominally at 60 Hz and 180 Hz (and optionally at 300 Hz) if interference at these frequencies is detected. These filters cause very little (but still not negligible) distortion. Then, because power line frequencies may drift from their nominal frequencies, the center frequencies of the filters are adapted to track the exact frequencies. To effectively eliminate the distortion caused by the IIR filter, the data mode transmit equalizer is adjusted. There is no way to undo the fundamental penalty caused by increased quantization noise that is caused by power line interference. However, with even moderate levels of echo, the added quantization from power line noise is small enough not to cause a degradation in performance.

In addition to addressing power line interference, the present invention addresses distortion that is introduced by certain telephone switches at or near DC (0 Hz). Similar to power line interference, distortion at DC will severely limit the performance of PCM upstream, if left uncompensated. The techniques described herein for rejecting power line interference can also be used to reject DC distortion. Rejecting DC distortion is a simpler process than filtering power line interference because the frequency does not need to be tracked. Additionally, the transmit equalizer typically does not include energy at DC and the compensation filter has only a very small affect on overall performance.

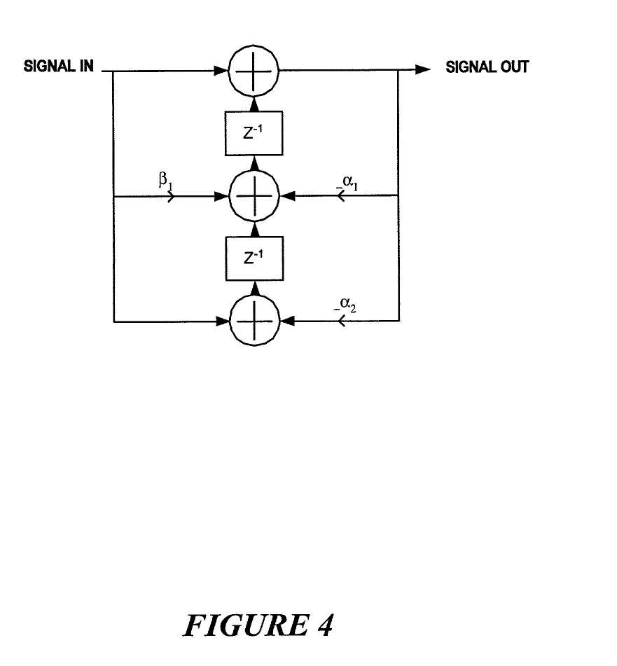

Referring to FIG. 4, for each power line interference frequency, a filter with two complex zeros on the unit circle and two complex poles just inside the unit circle is used to reduce the interference level. The filter can be described by the equation

$$H ( z ) = \frac{( 1 - {ⅇ}^{+ j ω T} {z}^{- 1} )}{( 1 - a {ⅇ}^{+ j ω T} {z}^{- 1} )} \frac{( 1 - {ⅇ}^{- j ω T} {z}^{- 1} )}{( 1 - a {ⅇ}^{- j ω T} {z}^{- 1} )}$$

where ω is the frequency of the interfering signal. The numerator of the filter can be expanded to yield

[1−2 cosωTz⁻¹+z²]

while the denominator is

[1−2a cosωTz⁻¹+a²z⁻²]

The filter can be implemented using two (or optionally three) stages of a direct form I filter illustrated in FIG. 4, wherein β₁=−2 cosωT, α₁=−2 a cosωT, and α₂=a². The values of a and −2 cosωT are stored as constants for the nominal frequencies. The actual values of β₁ and α₁ are calculated using the constants and applying offsets calculated from a timing recovery loop described in the next section. Although power line frequencies are very accurate over the long run, over the short term the frequency can drift significantly from the nominal frequency. The design of the present invention works even if the actual frequency is off by as much as ±10%.

The first step in the identification of the proper power line frequency occurs in V.92 short or long Phase II where the exact frequency and magnitude of any interference at both 60 Hz and 180 Hz is determined. A power threshold is used to determine power line interference. If either the 60 Hz or 180 Hz frequency rises above the threshold, then power line interference is flagged and IIR filters and transmit filter adjustment are applied. The exact frequencies are tracked throughout Phases III and IV and in data mode.

The Phase II signals are typically resampled to 9600 Hz During the long Phase II, a comb filter is applied to the L1/L2 received signals to reject all multiples of 150 Hz. For a simple infinite impulse response (IIR) filter

yₖ=xₖ−xₖ₋₆₄

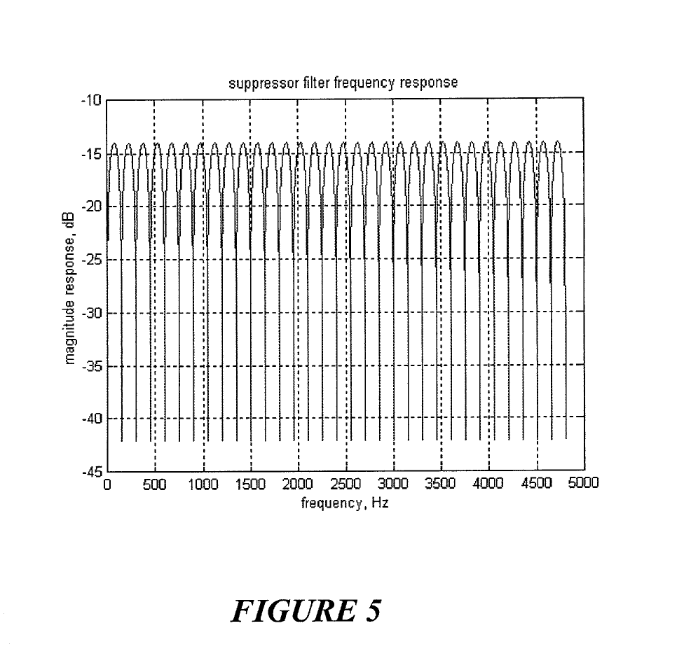

with x being the input, y the output, and k the time index is used. The frequency response of this filter is illustrated in FIG. 5. The filter will remove the 300 Hz component but the 60 Hz and 180 Hz components are not highly attenuated.

To the filtered output, the following Discrete Fourier Transform (DFT) at 60 Hz and 180 Hz is applied:

$${X}_{n} = {\sum }_{k} {x}_{k} {ⅇ}^{j 2 π nk / N}$$

With the probing sequence filtered, the magnitude of the DFT at these frequencies reflects only noise and any power line interference. A fast Fourier transform (FFT) is not used here because the only result of interest is from two frequencies. At 9600 Hz sampling frequency, an N=160 point discrete Fourier transform (DFT) is used, from which X₁ is the complex DFT results at 60 Hz and X₃ is the result at 180 Hz During V.92 Phases III and IV and data mode, the sampling frequency is 8000 Hz and an N=400 point DFT is used to track the frequency using the result at either X₃ or X₉.

In the preferred embodiment, m phase values of 160 point DFTs is used. If the frequency is not exactly 60 Hz or 180 Hz, then the phase of the DFT will rotate linearly from block to block with the slope of the angles proportional to the frequency offset. A linear interpolation of the m phase values is performed to determine the slope which is used to jump-start the frequency tracking in Phase III.

During short Phase II, as defined in V.92 “quick connect”, a similar procedure is followed except that the power line interference is detected while the client modem transmits the “A” signal. Because the power of the client signals is greatly reduced, less time is required to find and track the power line noise (m<25).

Contemporaneously, the magnitude is averaged over these same values. If the magnitude at either frequency is higher than the threshold, only one of the two frequencies is selected to calculate the frequency offset and to track during and beyond Phase III. If the measured magnitude of the 180 Hz signal is greater than 4 dB above the 60 Hz signal, the 180 Hz signal is tracked, otherwise we track the 60 Hz signal.

Linear interpolation of the m phase values is performed to estimate the exact frequency with the following formula The indices, i, of these samples are assumed to range from 0 to M−1. The formula for the slope is

$$\frac{m \sum iy - \sum i \sum y}{m \sum {i}^{2} - {( \sum i )}^{2}}$$

where y is the unwrapped angle value. If the value of y is the angle in radians from a 160 point DFT, the frequency offset in Hertz is the slope derived from the formula times 9600/2/π/160 for either 60 Hz and 180 Hz. When transitioning to Phase III, the frequency offset must first be converted from 9600 Hz, with a 160 point DFT to 8000 Hz with a 400 point DFT.

During Phase III+, the frequency is tracked using a second order phase-locked loop (PLL). The phase angle, θ, driving the loop is derived from the 400 point DFT at the selected frequency (either 60 Hz or 180 Hz). The equations used for the PLL are

φᵢ=θᵢ−\hat{θ}ᵢ₋₁

δᵢ=δᵢ₋₁+βφᵢ

\hat{θ}ᵢ=\hat{θ}ᵢ₋₁+αφᵢ+δᵢ

where δ converges to the offset frequency and φ converges to zero. An iteration of this loop is performed for every 400 samples during phases III, IV, and data mode.

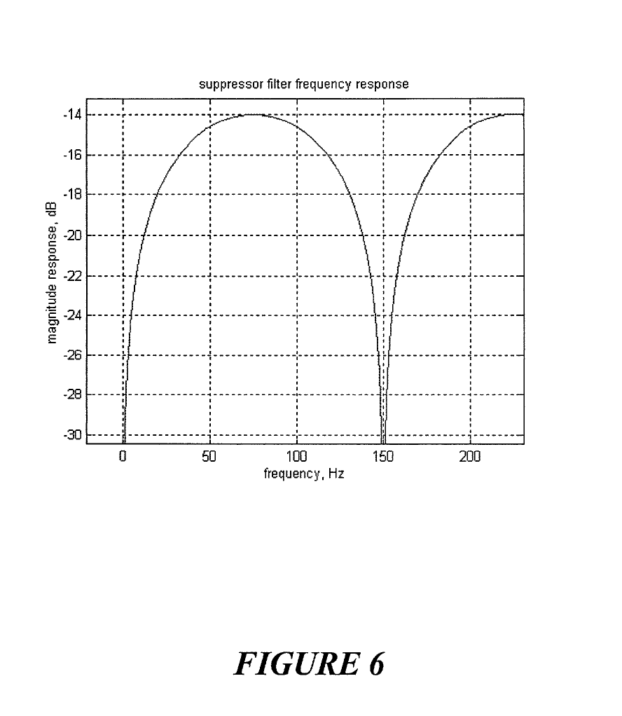

To update the IIR notch filters, the frequency offset, δ, is low-pass filtered and then used to update the pole and zero locations in the IIR filters. Updating is performed by calculating the new value for −2cosωT in the numerator and denominator of the IIR notch filter according to FIG. 6. The coefficients are then re-calculated and used by the IIR filters.

The very narrow IIR notch filters used in the preferred embodiment to attenuate power line noise have an impulse response that rings for a very long time at a very low level as illustrated in FIG. 5. Although the level is very low, the overall distortion can be significant. For the example in FIG. 6, the signal-to-distortion ratio is 31 dB, which is well above the noise floor. This causes two problems. The first is that the channel identification is not long enough to encompass all of the ringing, which means that the transmit equalizer design does not equalize all of the ringing. The second problem is that the IIR filter comes after the codec. To achieve the gain from PCM upstream, the levels received before the codec, excluding the echo, should match the constellation levels. If this is not the case, the quantization noise will be as high as it is in V.34 and there will be no advantage to PCM upstream over V.34. However, the digital receiver will decode values after the codec, echo canceller, and IIR filters. These levels must also match the designed constellation values.

The problems are solved by applying a pre-computed adjustment filter to the transmit equalizer, both to the feedforward and feedback filters. This application limits the ringing of the IIR filters. If the ringing is limited to only a few taps, this will have two effects. First, it will means that the channel identification will include all of the relevant energy from the IIR filters, and second, that the distortion that comes before the codec will be small.

If the feedforward filter is w, the feedback filter is b, and the channel is h, then the filters are designed so that b≅w*h where ‘*’ means ‘convolved with.’ Therefore, any adjustment we make to w we can also make to b without affecting the power of the equalizer error. For example, if we apply the adjustment filter, t, to w and to b, we have the new equations, b*t≅w*h*t.

The new feedforward filter would then be w*t and the new feedback filter b*t. For proper implementation of the preferred embodiment, the filter, b, is restricted to be monic (first tap equal to 1). The convolution b*t must continue to be monic which implies that the first tap of t be equal to 1. The inclusion of the filter, t, can increase the gain of the transmit equalizer. This translates directly into a lower data rate since the average transmit power must be maintained.

The filter, t is chosen to jointly minimize the energy of the tail of t*r, where r is the impulse response of the IIR filters, and ∥t∥2. This joint optimization is performed with Lagrange multipliers. The appropriate Lagrange multiplier is chosen so that the tail has acceptably small energy, usually about −50 dB.

With R as defined in equation (1) as

$$R = ( \begin{matrix}{r}_{0} & {r}_{1} & ⋯ & {r}_{v} & {r}_{v + 1} & ⋯ & 0 \\ 0 & {r}_{0} & ⋰ & & {r}_{v + 1} & ⋰ & \\ & & ⋰ & & & ⋰ & \\ 0 & & & {r}_{0} & & & \end{matrix} ) \\ ( {R}_{v} \vert {\overline{R}}_{v} ) \qquad ( 1 )$$

=

and t=[1t₁t₂. . . tₙ], the right half of R is known as \overline{R}v , the following should be minimized:

∥[1t₁t₂. . . tₙ]\overline{R}v∥²

while also maximizing:

∥[1t₁t₂. . . tₙ]∥²

The Lagrange multiplier problem is solved with:

$$\frac{\partial ( t {\overline{R}}_{v} {\overline{R}}_{v}^{′} {t}^{′} )}{\partial t} + λ \frac{\partial ( {tt}^{′} )}{\partial t} = 0$$

and λ is chosen so that ∥[t₁t₂. . . ]\overline{R}v∥² is more than the desired amount below 1 (e.g. 50 dB).

Because many varying and different embodiments may be made within the scope of the inventive concept herein taught, and because many modifications may be made in the embodiments herein detailed in accordance with the descriptive requirements of the law, it is to be understood that the details herein are to be interpreted as illustrative and not in a limiting sense.

What is claimed is:

1. A method to reduce the effects of power line interference affecting data transmissions in an upstream pulse code modulation (PCM) channel in a telecommunications network comprising:
detecting power line interference at specific frequencies in said channel; and
filtering said interference with at least one narrow notch filter

2. The method of claim 1, further comprising:
reducing distortion caused by the notch filter by applying an adjustment to the feedforward and feedback filters of the transmit equalizer.

3. The method of claim 1, wherein:
said step of detecting power line interference at specific frequencies is performed by using a filter to notch out client modem signals to detect said interference.

4. The method of claim 1, wherein:
said power interference filter has two complex zeros on the unit circle and two complex poles just inside the unit circle and is described as
$$H ( z ) = \frac{( 1 - {ⅇ}^{+ j ω T} {z}^{- 1} )}{( 1 - a {ⅇ}^{+ j ω T} {z}^{- 1} )} \frac{( 1 - {ⅇ}^{- j ω T} {z}^{- 1} )}{( 1 - a {ⅇ}^{- j ω T} {z}^{- 1} )}$$
where ω is the frequency of the interfering signal and the numerator of the filter can be expanded to yield
[1 −2 cosωTz⁻¹+z⁻²]
and the denominator is
[1−2a cosωTz⁻¹+a²z⁻²].

5. The method of claim 4, wherein:
said filter is implemented using a plurality of stages of a direct form infinite impulse response filter, wherein β₁=−2 cosωT, α₁=−2a cosωT, and α₂=a², and wherein the values of a and −2 cosωT are stored as constants for the nominal frequencies.

6. The method of claim 3, wherein:
said interference is detected during V.92 Phase 2 probing sequence with the following steps:
applying a discrete Fourier transform to the receive signal at frequencies of 60 Hz and 180 Hz; and
comparing detected interference at specific frequencies with a threshold frequency.

7. The method of claim 2, wherein:
the adjustment is a monic FIR filter applied to both the feedforward and feedback filters.

8. A method to reduce the effects of power line interference affecting data transmissions in an upstream pulse code modulation (PCM) channel in a telecommunications network, comprising:
adapting the center frequency of a notch filter to track the exact frequency of the interference when the interference drifts from the nominal interference frequency.

9. The method of claim 8, wherein:
adapting the notch filter to track the frequency of the interference includes tracking the interference after V.92 phase 2 using a phase-locked loop.

10. The method of claim 9, further comprising:
updating the notch filter center frequency by low-pass filtering the frequency offset of a phase-locked loop in said filter used to track the frequency of the interference, and
using said offset to update the pole and zero locations in an IIR filter.

11. A device to reduce the effects of power line interference affecting data transmissions in an upstream pulse code modulation (PCM) channel in a telecommunications network, comprising:
a notch filter for detecting power line interference at specific frequencies in said channel; and filtering said interference from said channel.

12. The device of claim 11, further comprising:
a data mode transmit equalizer that is adjusted to reduce distortion caused by the filter.

13. The method of claim 11, wherein:
the notch filter detects power line interference at specific frequencies to notch out client modern signals.

14. The device of claim 13, wherein:
said filter has two complex zeros on the unit circle and two complex poles just inside the unit circle and is described as
$$H ( z ) = \frac{( 1 - {ⅇ}^{+ j ω T} {z}^{- 1} )}{( 1 - a {ⅇ}^{+ j ω T} {z}^{- 1} )} \frac{( 1 - {ⅇ}^{- j ω T} {z}^{- 1} )}{( 1 - a {ⅇ}^{- j ω T} {z}^{- 1} )}$$
where ω is the frequency of the interfering signal and the numerator of the filter can be expanded to yield
[1−2 cosωTz⁻¹+z⁻²]
and the denominator is
[1−2a cosωTz⁻¹+a²z⁻²].

14. The device of claim 13, wherein:
said filter is implemented using a plurality of stages of a direct form infinite impulse response filter, wherein β₁=−2 cosωT, α₁=−2a cosωT, and α₂=a², and wherein the values of a and −2 cosωT are stored as constants for the nominal frequencies.

15. The device of claim 3, wherein:
said filter detects interference during V.92 Phase 2 probing sequence by applying a discrete Fourier transform to the received signal at frequencies of 60 Hz and 180 Hz; and
comparing detected interference at specific frequencies with a threshold frequency.
and to track the exact frequency of the interference when the interference drifts from the nominal interference frequency by adapting the center frequency of the IIR filter.

16. The device of claim 11, further comprising:
the filter is updated by low-pass filtering the frequency offset of a phase-locked loop in said filter used to track the frequency of the interference; and
using said offset to update the pole and zero locations in the filter.

17. A method to reduce the effects of power line interference affecting data transmissions in an upstream pulse code modulation (PCM) channel in a telecommunications network, comprising:
a notch filter to track the frequency of the interference when the interference drifts from the nominal interference frequency by adapting the center frequency of the notch filter.

18. The method of claim 17, further comprising:
reducing distortion caused by the notch filter by applying an adjustment to the feedforward and feedback filters of the transmit equalizer.

19. The device of claim 17, wherein:
the notch filter is adapted to track the frequency of the interference includes tracking the interference after V.92 phase 2 using a phase-locked loop.

20. The device of claim 18, wherein:
the adjustment is performed by a monic FIR filter applied to both the feedforward and feedback filters.

21. A method to reduce the effect of power line interference affecting data transmission in an upstream pulse code modulation (PCM) channel in a telecommunications network, comprising:
detecting distortion at or near direct current (DC) in said channel; and
filtering said distortion with at least one narrow notch filter.

22. The method of claim 21, further comprising:
reducing distortion caused by the notch filter by applying an adjustment to the feedforward and feedback filters of the transmit equalizer.

23. The method of claim 21, wherein:
said step of detecting distortion at or near DC is performed by using a filter to notch out client modem signals to detect said interference.

24. The method of claim 21, wherein:
said power line interference filter has two complex zeros on the unit circle and two complex poles just inside the unit circle and is described as
$$H ( z ) = \frac{( 1 - {ⅇ}^{+ j ω T} {z}^{- 1} )}{( 1 - a {ⅇ}^{+ j ω T} {z}^{- 1} )} \frac{( 1 - {ⅇ}^{- j ω T} {z}^{- 1} )}{( 1 - a {ⅇ}^{- j ω T} {z}^{- 1} )}$$
where ω is the frequency of the interfering signal and the numerator of the filter can be expanded to yield
[1−2 cosωTz⁻¹+z⁻¹]
and the denominator is
[1−2a cosωTz⁻¹+a²z²].

25. The method of claim 21, wherein:
said DC distortion filter has two real zeros on the unit circle and two complex poles just inside the unit circle and is described as
$$H ( z ) = {( \frac{( 1 - {z}^{- 1} )}{( 1 - {az}^{- 1} )} )}^{2}$$

26. The method of claim 24, wherein:
said filter is implemented using a plurality of stages of a direct form infinite impulse response filter, wherein β₁=−2 cosωT, α₁=−2a cosωT, and α₂=a², and wherein the values of a and −2 cosωT are stored as constants for the nominal frequencies.

27. The method of claim 25, wherein:
said filter is implemented using a plurality of stages of a direct form infinite impulse response filter, wherein β₁=−2, α₁=−2a, and α₂=a², and wherein the value of a is stored as a constant.

28. The method of claim 23, wherein:
said interference is detected during V.92 Phase 2 probing sequence with the following steps:
applying a discrete Fourier transform to the receive signal at 0 Hz; and
comparing detected interference at specific frequencies with a threshold frequency.

29. A device to reduce the effects of power line interference affecting data transmissions in an upstream pulse code modulation (PCM) channel in a telecommunications network comprising:
a notch filter for detecting distortion at or near DC in said channel; and
filtering said distortion from said channel.

30. The device of claim 29, further comprising:
a data mode transmit equalizer that is adjusted to reduce distortion caused by the filter.

31. The method of claim 29, wherein:
the notch filter detects power line interference at specific frequencies to notch out client modem signals.

32. The device of claim 29, wherein:
said filter has two complex zeros on the unit circle and two complex poles just inside the unit circle and is described as
$$H ( z ) = \frac{( 1 - {ⅇ}^{+ j ω T} {z}^{- 1} )}{( 1 - a {ⅇ}^{+ j ω T} {z}^{- 1} )} \frac{( 1 - {ⅇ}^{- j ω T} {z}^{- 1} )}{( 1 - a {ⅇ}^{- j ω T} {z}^{- 1} )}$$
where ω is the frequency of the interfering signal and the numerator of the filter can be expanded to yield
[1−2 cosωTz⁻¹+z²]
and the denominator is
[1−2a cosωTz⁻¹+a²z²].

33. The method of claim 29, wherein:
said DC distortion filter has two real zeros on the unit circle and two complex poles just inside the unit circle and is described as
$$H ( z ) = {( \frac{( 1 - {z}^{- 1} )}{( 1 - {az}^{- 1} )} )}^{2}$$

34. The device of claim 29, wherein:
said filter is implemented using a plurality of stages of a direct form infinite impulse response filter, wherein β₁=−2 cosωT, α₁=−2a cosωT, and α₂=a², and wherein the values of a and −2 cosωT are stored as constants for the nominal frequencies.

35. The device of claim 29, wherein:
said filter is implemented using a plurality of stages of a direct form infinite impulse response filter, wherein β₁=−2,α₁=−2a, and α₂=a², and wherein the value of a is stored as a constant.

36. The device of claim 29, wherein:
said filter detects interference during V.92 Phase 2 probing sequence by applying a discrete Fourier transform to the received signal at 0 Hz and comparing detected interference at specific frequencies with a threshold frequency.
